(19) United States
(12) Patent Application Publication
(10) Pub. No.: US 2022/0148457 A1
(43) Pub. Date: May 12, 2022

(54) PRINTED MATTER WITH IDENTIFICATION CODE FOR VISUALLY IMPAIRED PERSONS ADDED

(71) Applicant: EXPORT JAPAN INC., Osaka-Shi, Osaka (JP)

(72) Inventor: Kenji TAKAOKA, Osaka-Shi, Osaka (JP)

(21) Appl. No.: 17/433,339

(22) PCT Filed: Jul. 12, 2019
(86) PCT No.: PCT/JP2019/027661

§ 371 Date: Oct. 21, 2021

(30) Foreign Application Priority Data
Feb. 26, 2019 (JP) 2019-032403

(51) Int. Cl. G09B 21/00; G06K 19/06; G06K 7/14

(52) U.S. Cl. CPC G09B 21/004; G09B 21/006; G06K 7/1417; G06K 19/06037

(57) ABSTRACT

Proposed is an identification code for visually impaired people on printed matter to enable people with visual impairments to understand the information printed on the packaging or the contained product's information. In terms of printed matter with this identification code for visually impaired people, the identification code for visually impaired people is readable by a mobile device that has a camera and a specified code reading function, is displayed on the surface of the printed material, has Braille-like convex points projecting outward at multiple points around the identification code for visually impaired people, and has a predetermined distance from center to center of each convex point that is greater than the distance from center to center in the most laterally separated raised dots in adjacent Braille cells.

### TECHNICAL FIELD

The present invention relates to product packaging with an identification code specifically for people with visual impairments so that visually impaired people can easily access and understand the information written on the product or printed material.

### BACKGROUND TECHNOLOGY

Visually impaired people are often at a disadvantage in their daily lives because of the limited amount of information they can obtain from non-audible sources. In the past, excluding audible sources, visually impaired people mainly acquired information through Braille, and it was difficult to acquire information from items that did not have Braille on them. In addition, each country has its own system of Braille and writes it according to their system, and this, combined with the difficulty of writing Braille side by side, has become a hindrance for visually impaired people to obtain information overseas and purchase foreign products. Furthermore, when visually impaired tourists come from other countries, the means of providing information to them are very limited.

In addition, it is said that only about 10% of people with visual impairments have a complete understanding of Braille, and there is an overwhelming lack of methods for providing information to visually impaired people, especially those who acquire visual impairments. On the other hand, in recent years, there has been an increase in the number of visually impaired people who use the voice reading functions (VoiceOver and TalkBack) and related applications of mobile phones and devices to access and understand text posted on the internet by converting it into spoken information. (See Patent Reference 1, Non-Patent Reference 1, Non-Patent Reference 2, and FIG. 11). With this change, the amount of information available to the visually impaired, including those who cannot understand Braille, is greatly increasing.

In addition, since automatic translation functions (Patent Document 2) are originally included in smartphone applications or can be installed later, there are visually impaired people who utilize these functions to translate documents written in foreign languages and use the above-mentioned read-aloud function to obtain information audibly.

However, even for visually impaired people who utilize the text-to-speech function of smartphones, it is still difficult to recognize non-textual information on the internet through read-aloud technology. For example, product descriptions, ingredients, expiration dates, etc., on the packaging of products manufactured overseas are written in foreign languages, and although a portion of these products may be translated, it is difficult for the visually impaired to understand them. This is not limited to foreign products, as it can be impossible to put Braille on various generic products or on ordinary printed matter even in one's own language, and it is also difficult for visually impaired people to immediately understand detailed information on products or information on printed matter when shopping or reading.

There are, however, known methods of printing an identification code (2D code) on a published text and providing the document to a mobile device, such as a smartphone, that can decode the identification code using an identification code reading application. Among these methods, for example, Patent Document 3 describes the idea of displaying a 2D code on a document and using this 2D code to obtain a written or spoken translation of that document from the internet. In addition, in Patent Reference 4, the inventor provides a technology for a mobile device to read a 2D code on a document or the like posted in a public space, etc., and to display a translated version of that text in the language set on the mobile device.

However, none of them are specifically intended for visually impaired people, and they are made to read identification codes such as two-dimensional codes when purchasing products and reading books for visually impaired people so that they can understand the contents of products and information in printed matter. It has not yet provided the best mode and its effectiveness to society.

### PRIOR TECHNOLOGY REFERENCES

### Patent References

Patent Reference 1: Patent No. 4011095

Patent Reference 2: Patent No. 6443689

Patent Reference 3: Patent Publication No. 2009-157894

Patent Reference 4: Patent No. 4918174

### Non-Patent References

Non-Patent Reference 1: Watanabe Tetsuya, Yamaguchi Toshimitsu, Minatani Kazunori. (2014). Research investigation report No. 29. “Survey of Mobile Phone Usage by the Visually Impaired People.” The Telecommunications Advancement Foundation.

Non-Patent Reference 2: Watanabe, T. (2017). An Analysis of Differences among Residences in the usage of Communication Support Services and ICT Devices by Blind and Visually Impaired People. Journal of the National Institute of Public Health, Vol. 66, No. 5, pp. 523-531.

### OVERVIEW OF THE INVENTION

### Problem to be Solved by the Invention

The present invention has been created in view of the above circumstances, and its purpose is to provide product packaging, such as paperboard boxes, with identification codes for visually impaired people that can be quickly recognized by visually impaired people and scanned using mobile devices, such as smartphones, so that the visually impaired person can easily access and understand the product's information and contents.

### Means to Solve the Problem

The present invention has been created to achieve the above object.

Product packaging in which a product to be ingested orally is contained and an identification code for visually impaired people which is printed on the surface of the product packaging.

It can be read by a mobile device with a camera function and a specified identification code reading function, and is composed of a 2D code displayed on the surface of the product packaging.

As a mark for visually impaired people to notice the existence of the 2D code, the surface of the product packaging is marked with a concave recess area with a square-shaped bottom.

The 2D code can be read with a mobile device by the visually impaired person and output by voice with the mobile device to understand the information stored in the 2D code about the product to be orally ingested. The code is displayed on the surface of the concave recess. The code is square in shape with a side length of 10 mm or more.

The side of said concave area is longer than the side of said 2D code.

Furthermore, in the present invention, in order for a visually impaired person to access and understand the written information on the product they have picked up, the product is packaged and an identification code (bar code or data matrix 2D code) for visually impaired people is printed on the surface of the product packaging. With the present invention, in order to resolve the issue that the product information printed on the product packaging cannot be accessed when a visually impaired person purchases a product at a mass retailer etc., as described above, the identification code for visually impaired people is printed on the product packaging. Additionally, the identification code for visually impaired people may be printed directly on the product packaging, and multiple Braille-shaped protrusions may be placed around the 2D code.

The inventor has conducted various proof of concept tests, and the presence of the code can be immediately detected, while still ensuring the usability of the code as an identification code for visually impaired people that can be read by at least a generic camera and a generic 2D code reader, by placing multiple Braille-like convex points around the 2D code printed on the identification code as markers that indicate its presence, or by placing the entire identification code for visually impaired people in a square-shaped concave area on the surface of the product packaging. When Braille-shaped convex points are used, people can easily recognize that it is an identification code for visually impaired people rather than standard Braille by making the distance between each convex point larger than the distance between normal Braille raised dots. Here, “normal Braille spacing” refers to the distance from center to center of the six points in adjacent cells that are farthest apart in the horizontal direction, specifically the distance between the center of point (1) in one cell and point (4) in the adjacent cell. Normally, if the convex points are farther apart than this distance between the points, a visually impaired person will notice the discrepancy and instantly recognize that the convex points are not Braille indicating a character sign and therefore are able to understand that the points are enclosing a 2D code.

The 2D code of the identification code for visually impaired people can be printed directly on product packaging or it can be printed as a sticker, and convex points can be placed around the 2D code.

Additionally, the said identification code for visually impaired people is typically a matrix data 2D code (like QR codes (registered trademark), hereinafter, in this specification and the drawings, “QR codes”), and the said convex area is formed at the four corners around said 2D code.

These product packaging 2D codes are highly popular because they can record a large amount of information (e.g., website URLs) by arranging dots horizontally and vertically, and there is no need to prepare a separate dedicated reading application for current smartphones. In addition, if the convex points of the Braille dot-like shapes are placed at four points in line with the four corners of the 2D code, and the 2D code is enclosed by a square, visually impaired people can recognize where the square-shaped 2D code is regardless of the angle at which the item is being held, shortening the time needed to scan the code. Furthermore, using four convex points leads people to picture a square. This means that the distance between two points can be judged quickly by the exact length and width without judging the distance diagonally, and it is also advantageous in that it can immediately be recognized as soon as it is touched as an identification code for visually impaired people that uses a 2D code, rather than Braille.

The said 2D code is preferably a square measuring at least 10 mm, and the distance from center to center of each convex point is preferably 14 mm or greater.

For 2D codes for visually impaired people, a smaller printing space is desirable in consideration of the extra space on product packaging, as well as the task of holding a smartphone in one hand and searching for the convex points with the fingertips of the other; if the distance between the convex points is too wide, the four points cannot be simultaneously detected by the fingertips. Conversely, from the viewpoint of increasing the success rate of reading 2D codes, and from the viewpoint that the above-mentioned distance between convex points needs to be larger than the distance between normal Braille cells, the 2D codes and the distance between convex points needs to be larger than the specified size. From the results of the test described later, the size of the code is preferably 10.0 mm or more in order to maintain a high reading success rate of the 2D code. In addition, taking into consideration the accuracy and technology of making convex points, the prevention of overlaps with 2D codes due to center misalignment, and the effects of a convex point's shadow, it is desirable to offset the center of convex points and the 2D code for visually impaired people by about 2 mm. In addition, taking into consideration the accuracy and technology of making convex points, the prevention of overlaps with 2D codes due to center misalignment, and the effects of a convex point's shadow, it is desirable to offset the center of convex points and the 2D code by about 2 mm. Therefore, given these various circumstances, the above threshold value is thought to be appropriate.

Furthermore, the appropriateness of the 2D code is clear from the results of the proof of concept tests described below. It should be a square of no less than 10 mm and no more than 14 mm, and the distance from center to center of each convex point should be no less than 14 mm and no more than 18 mm.

It is also preferable that the convex points are half-dome shaped, with a base diameter between 1.0 mm and 1.7 mm and a height of between 0.3 mm and 0.7 mm.

If the convex points are half-dome shaped, like un upside-down saucepan, it satisfies the requirements of Braille, in which dots are a certain height to make them easy to read while being round to minimize stimulation of the fingertips, and they are easy for visually impaired people to get used to. In addition to this, half-dome shapes are not common Braille shapes, and they are easy to make on a generic product packaging production line, and does not require a Braille production machine.

Furthermore, the convex points and their shadows are unlikely to overlap with the 2D code, even if the convex points are quite close to it. Both of these points are advantageous from the viewpoint of marketability and usability.

Furthermore, as described above as another invention, on product packaging for a product to be orally ingested where an identification code for a visually impaired person is printed on the surface thereof, the identification code for the visually impaired person is readable by a mobile device with a camera function and a specified identification code reading function. A 2D code that can be read by a mobile device with a code reading function is displayed on the surface of the product packaging and acts as a mark for visually impaired people to notice the existence of the 2D code on the surface of the product packaging.

The information of the product to be orally ingested is stored in a 2D code which can be read by the visually impaired person with a mobile device and voice which can be output by the mobile device. The whole code is displayed in the bottom of the concave recess on the product packaging, and is square in shape with a side length of 10 mm or more, and the length of one side of the concave recess is larger than one side of the 2D code.

In the present invention described above, an example has been shown in which convex points are arranged around a general-purpose 2D code as a marker for a visually impaired person. However, the entire 2D code can also be printed in the concave area for tactile recognition. In this case as well, from the results of the test, it is desirable that each side of the 2D code is 10 mm or more in length, and each side of the bottom of the concave recess is larger than each side of the 2D code so as not to overlap with the 2D code.

Additionally, if the printed material bears an identification code for visually impaired people to help them to understand the information printed on the packaging of the 3D object or the contained product's information, when

a visually impaired person scans the identification code for visually impaired people with their mobile device, a web page containing detailed information on the product (3D object) is displayed. Ideally, the visually impaired person can thereby receive spoken detailed information on the product through the voice reading function of their mobile device.

When the identification code for visually impaired people is the printed packaging of a product (3D object), the address (URL) of the page containing detailed information on the product is recorded in the identification code for visually impaired people. The visually impaired person can scan the identification code for visually impaired people with the code reading function of a mobile device, such as a smartphone, to access the page, and then use the voice reading function of the mobile device to read aloud the page, enabling the visually impaired person to access detailed information on the product. Therefore, by utilizing the present invention, the desired information, such as ingredients in food items, can be easily understood by ear when purchasing products at mass retailers. It is also advantageous for product manufacturers to be able to communicate detailed product information appropriately to visually impaired people simply by creating the relevant page on their website, without having to add special displays or functions, or request that individual mass retailers accommodate visually impaired customers.

### Effectiveness of the Invention

According to the product packaging to which the identification code for visually impaired people of the present invention is attached, a 2D code indicating information on the contents of the product is printed on the surface of the product packaging, and the convex portions surrounding the 2D code at predetermined intervals or the concave recess that contains the entire 2D code on the bottom allows a visually impaired person who picks up the product to quickly recognize the existence of the identification code for visually impaired people containing a 2D code, and easily read the code with a mobile device such as a smartphone. As a result, the product's contents and information can be quickly and easily understood on site.

### BRIEF DESCRIPTION OF THE DRAWING

FIGS. 1A-B: The test objects used in proof of concept Test 1: FIG. 1A shows four pieces of paper for the test, and one 2D code is printed on each piece of paper in the top left, top right, bottom left, and bottom right corners respectively. Each code is the same size. FIG. 1B shows four types of products purchased at a mass retailer, each of which has a 2D code printed on it, with convex marks around the code so that the location of the 2D code can be recognized by touch. Furthermore, we also prepared unmarked products for two of the product types for comparison.

FIGS. 2A-2B: The breakdown of participants. FIG. 2A shows the breakdown of male and female participants and FIG. 2B shows the breakdown of participants in terms of their level of vision (blind or low vision) in Test 1.

FIGS. 2C-E: The percentage of participants with visual impairments in Test 1 who have experience using various items. FIG. 2C shows the percentage of people who use Braille, FIG. 2D shows the percentage of people who have used smartphones, and FIG. 2E shows the percentage of people who have used 2D codes.

FIGS. 3A-3C: FIGS. 3A-3B show the number of people (out of 100) who succeeded in reading the 2D codes printed in each position on the paper in FIG. 1A within one minute before and after being given instructions, respectively, during Test 1. FIG. 3C shows the breakdown of the success rate of reading 2D codes on products purchased at a mass retailer in FIG. 1B (six types of 3D objects classified by the presence or absence of tactile recognition marks and by shape).

FIGS. 3D-3F: FIGS. 3D and 3E show the number of people who succeeded in reading the 2D code within one minute on products shown in FIG. 1B that were purchased from a mass retailer during Test 1. The same products were used, only differing in terms of whether the 2D code was marked with a tactile recognition mark or not. FIG. 3F shows the percentage of people who succeeded in reading the 2D code within one minute according to the shape of the product (3D object).

FIGS. 4A-4B: The objects used in proof of concept Test 2. FIG. 4A shows test papers (A4 size paper with a 2D code of about 1.4 cm length printed on the bottom right side) both with and without a cut on the lower right corner; FIG. 4B shows test papers (A4 size paper) with a cut and with a 2D code of 0.6 cm, 0.8 cm, 1.0 cm, and 1.2 cm respectively printed on them. FIG. 4C: The objects used in Test 2. FIG. 4C shows two types of products (printed product packaging) printed with 2D codes (rectangular and cylindrical). In total, eight variations of 2D code placements were prepared. They are, respectively, rectangular (without mark), rectangular (convex), rectangular (concave), rectangular (with convex points), rectangular (with seal), cylindrical (without mark), cylindrical (with seal), and cylindrical (with convex points).

FIGS. 5A-5B: The breakdown of participants. FIG. 5A shows the breakdown of male and female participants and FIG. 5B shows the breakdown of participants in terms of their level of vision (blind or low vision) in Test 2.

FIGS. 5C-5E: The percentage of participants with visual impairments in Test 2 who have experience using various items. FIG. 5C shows the percentage of people who use Braille, FIG. 5D shows the percentage of people who use smartphones, and FIG. 5E shows the percentage of people who have used 2D codes.

FIGS. 6A-6B: A breakdown of results of Test 2. FIG. 6A shows the breakdown of the success rate (within one minute) of reading the 2D code of the printed material on the right-hand side in FIG. 4A in which a 2D code of 14 mm×14 mm is printed on the lower right side and the lower right edge of the paper is cut diagonally. FIG. 6B shows the breakdown of the success rate (within one minute) of reading the 2D code of the printed material on the left-hand side of FIG. 4A in which a 2D code of 14 mm×14 mm is printed on the lower right side but the is lower edge is not cut.

FIGS. 7A-7C: A breakdown of results of Test 2. FIG. 7A is a breakdown of the success rate (within one minute) of reading the 2D code when 2D codes of 0.6 cm, 0.8 cm, 1.0 cm, and 1.2 cm length were randomly printed on the demonstration paper (A4 size) with any cutouts as shown in FIG. 4B. FIG. 7B is the breakdown of the success rate (within one minute) of reading the 2D code when the 2D code printed on the product (rectangular product packaging) in FIG. 4C was randomly presented with different tactile recognition marks. FIG. 7C is the breakdown of the success rate (within one minute) of reading the 2D code when the 2D code printed on the product (cylindrical product packaging) in FIG. 4C was randomly presented with different tactile recognition marks.

FIG. 8: An example of a 2D code for use by visually impaired people as an model of the present invention.

FIGS. 9A-9C: FIG. 9A is a schematic diagram of the cross-sectional shape of each convex point, FIG. 9B is its dimensions, and FIG. 9C is a cross-section of standard Braille raised dots. (Source: Kizuka, Y. (1998). Size and feeling of braille: Nihonno Tenji, No. 23, pp. 19-23.)

FIGS. 10A-10B: List of distances from center to center of Braille raised dots in each country's Braille systems. (Source: Kizuka, Y. (1998). Size and feeling of braille: Nihonno Tenji, No. 23, pp. 19-23).

FIG. 11: Trends in the utilization rates of various ICT devices from the past (2013) to the present (2017) for visually impaired people by total blindness/low vision (see Non-Patent Reference 1 and Non-Patent Reference 2).

### FORM OF IMPLEMENTING THE INVENTION

Implementation of the present invention will be described in detail below with reference to diagrams.

First, we will explain data matrix 2D codes (also known as “QR codes,” registered trademark No. 4075066) as identification code images to be read as identification codes for visually impaired people. (Hereinafter, “identification code” is referred to as “2D code” as a typical example.) There are various problems in terms of recognizing a 2D code attached to a product. The inventor has conducted various tests to determine the problems that visually impaired people face. An example of a test conducted is outlined below as a premise for explaining the implementation of the present invention.

Proof of Concept Test 1 (Conducted Between Aug. 3, 2017, and Mar. 16, 2018)

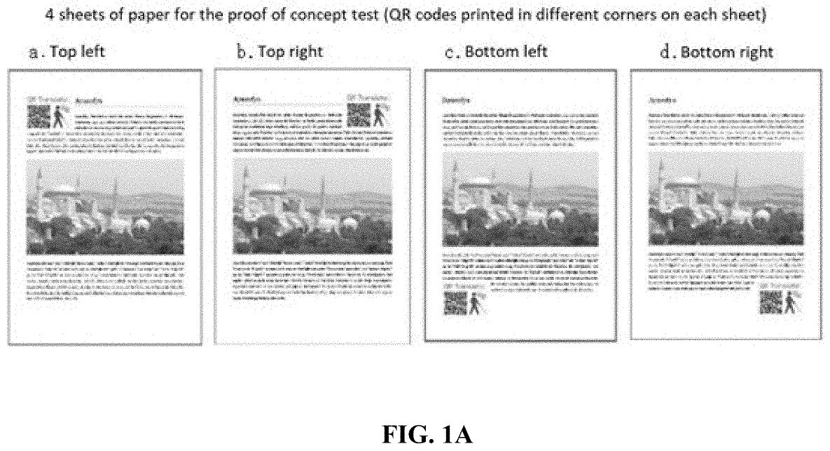

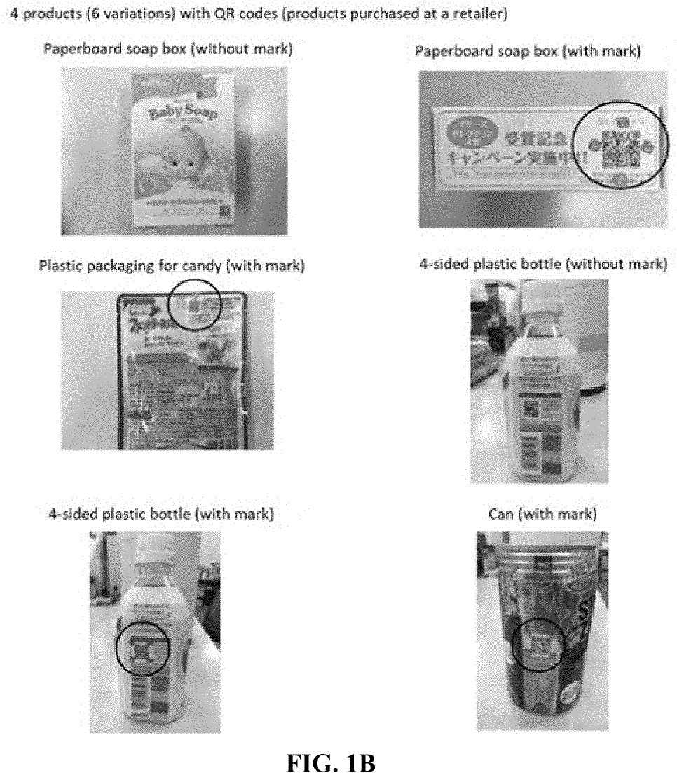

In Test 1, participants were seated in a well-lit room and used their smartphones (with a 2D code reading application installed) to scan the test objects placed on the specified table. Each object had a 2D code printed on it in a different location. The objects for the test were four sheets of test paper with 2D codes printed in different positions, as shown in FIG. 1A, and four 3D products purchased from mass retailers with 2D codes printed in various positions, as shown in FIG. 1B, with two of those products having tactile protrusions around the 2D codes and two products having no tactile markers. In total, six types of items were prepared. The assistants, seated next to participants, were asked to use a stopwatch to measure the time required to successfully read the code and record how participants scanned the code. We also measured the amount of time it took to scan the code both before and after receiving instructions on scanning 2D codes. (It becomes easier to read the code if the smartphone camera is held 20-40 centimeters above the object and the camera is steadied, for example, by resting the smartphone against one's chin.) Four products are shown in FIG. 1B: baby soap (six-sided box), gummy candy (bag with varying concave-convex shapes), aojiru green juice (four-sided plastic bottle), and a canned alcoholic beverage (cylindrical aluminum can).

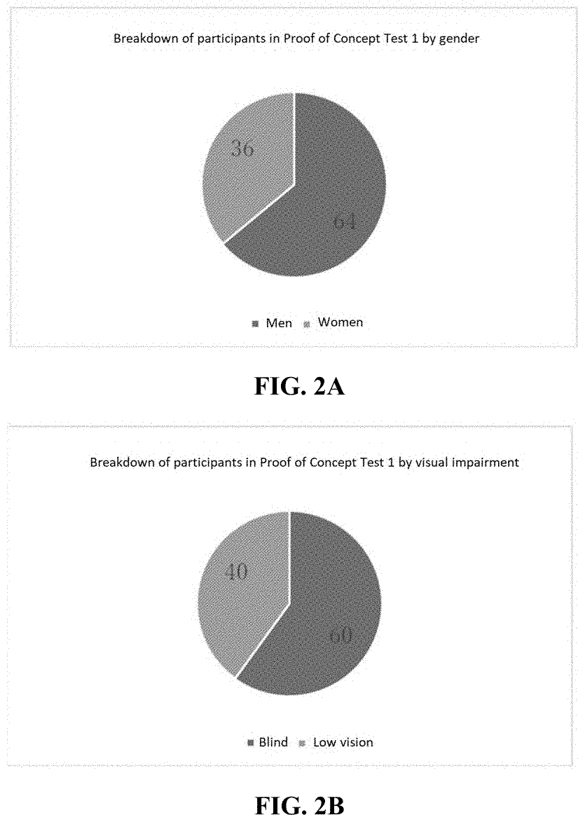

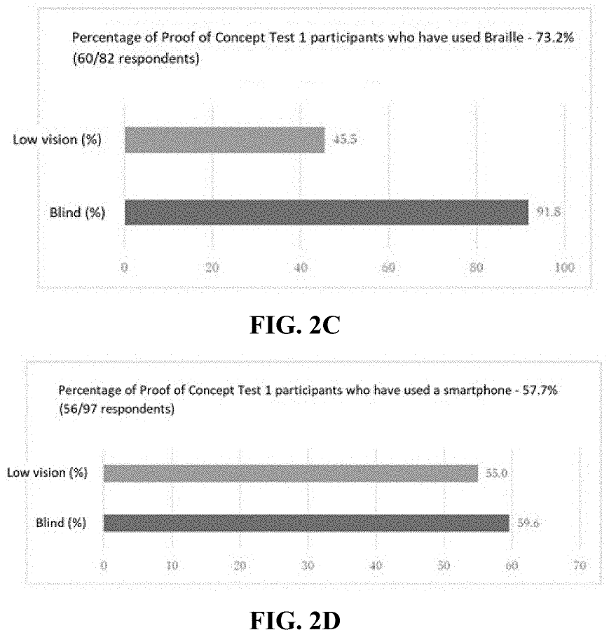

There were 100 visually impaired participants, 64 males and 36 females, with an average age of 55 (mean age of respondents); 60 of the participants were blind and 40 had low vision; and 73.2% (60 out of 82 respondents) used Braille (see FIGS. 2A-2B and FIG. 2C). FIG. 2C shows the breakdown of the percentage of Braille users. The necessity of acquiring information by voice can be understood through the particularly small number of Braille users among participants with low vision. In addition, the percentage of people who have used smartphones is 57.7% (56 out of 97 respondents), the percentage of people who have used smartphones' voice reading function (VoiceOver or TalkBack) is 46.9% (46 out of 98 respondents), and the percentage of people who have scanned 2D codes is 39.4%. Hence, it can be inferred that visually impaired people already use voice-reading functions and 2D codes with smartphones.

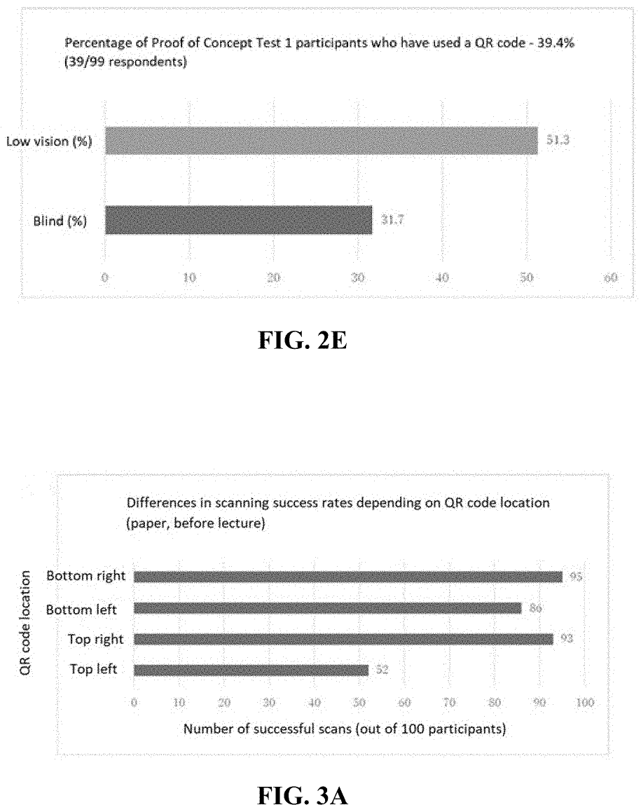

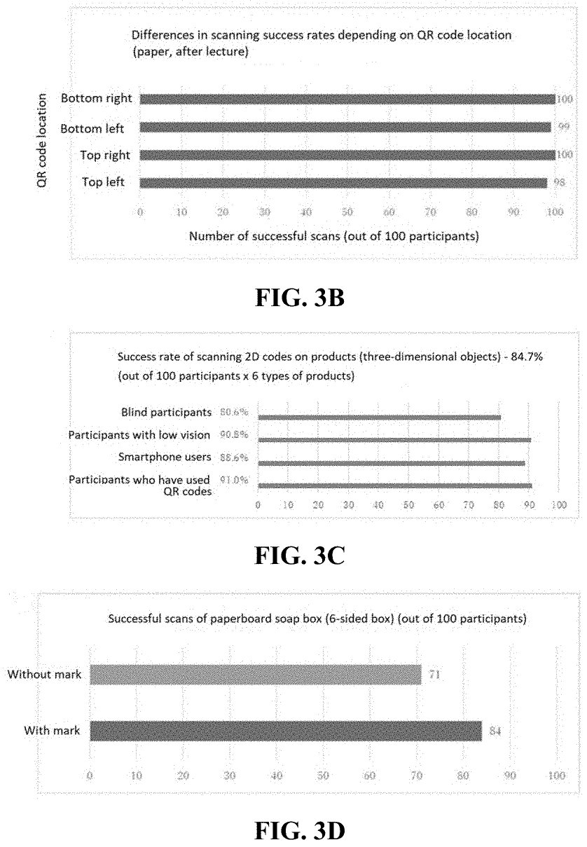

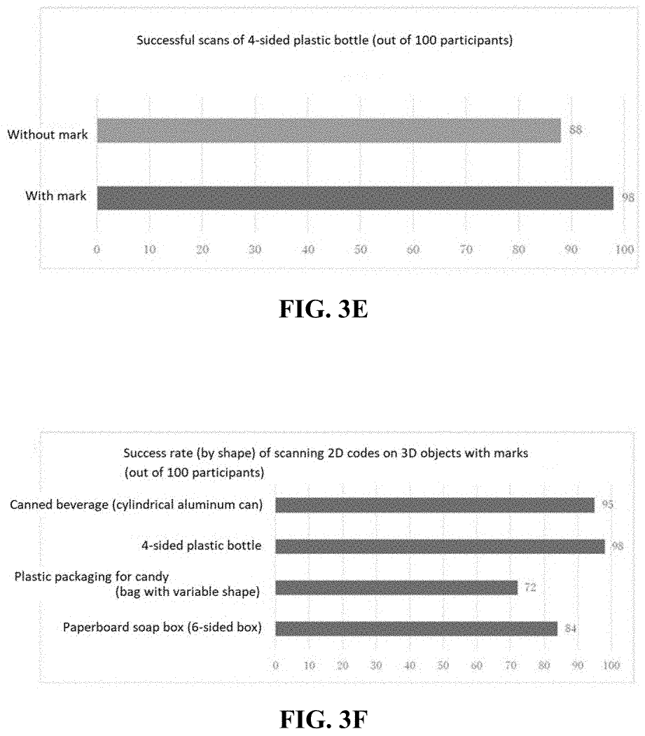

As a result of Test 1, the number of participants out of 100 who succeeded in scanning the 2D code printed on the piece of paper in FIG. 1A above within one minute (before instructions were given for this test) at each position was 52 for the upper left position, 93 for the upper right position, 86 for the lower left position, and 95 for the lower right position, as shown in FIG. 3A. On the other hand, after receiving instruction, 98 participants were successful in scanning the code when it was in the upper left, 100 in the upper right, 99 in the lower left, and 100 in the lower right, as shown in FIG. 3B. The reason why the number of successful participants before instruction was given is extremely low for the 2D code in the lower left corner compared to the other data is most likely due to the fact that the very first reading for all participants was for the lower left corner. This was evident by the fact that the number of successful participants for the same “lower left” position greatly improved after participants received instruction, leading to the decision to randomize the order of scanning for comparison in Test 2, described below. In addition, observation of the test showed that among the participants who failed to read the 2D code placed on the left side of the paper, there were cases where some participants covered the 2D code with their left hand while holding their smartphone in their right.

The success rate of 100 people reading 2D codes on six different products (3D objects) purchased from mass retailers, as shown in FIG. 1B above, was 84.7% (508 times/600 times), as shown in FIG. 3C. The breakdown was 80.6% (290/360 times) for blind people, 90.8% (218/240 times) for people with low vision, 88.6% (298/336 times) for smartphone users, and 91.0% (213/234 times) for people with experience using 2D codes. All the reading tests of 3D objects were conducted after receiving instruction, and it was found that, regardless of the shape of the product, the reading success rate of 3D objects was slightly lower than that of flat printed matter (paper). The difference in the success rate for each profile of the participants demonstrates a higher success rate among those with low vision, and a higher success rate for those who already had experience using smartphones and 2D codes compared to those with no experience. It was thought that the success rate was higher for people with low vision because people with low vision could determine the presence of the 2D code and its location, albeit not perfectly. Additionally, it was thought that the success rate was improved by participants' degree of proficiency in scanning the code, as the success rate was higher for those who had experience using smartphones and 2D codes and also improved after receiving instructions.

As shown in FIG. 3D and FIG. 3E, a difference of 10 to 13% in success rate was observed in the same 3D object between printing position of the 2D code being marked and being unmarked. For the baby soap (6-sided box) shown in FIG. 1B, the success rate was 84% (84 out of 100) with a tactile marker and 71% (71 out of 100) without. For aojiru green juice (4-sided PET bottle) shown in FIG. 1B, the success rate was 98% (98 out of 100) with the tactile marker and 88% (88 out of 100) without. Therefore, it was found that the success rate increased when the location of the 2D code could be determined via touch. It was decided to verify exactly what kind of tactile recognition marker was the best to indicate the location of the 2D code in Test 2.

As shown in FIG. 3F, the success rate of reading the 2D code placed on various shapes of product packaging depicted in FIG. 1B (all with tactile markers around the 2D code) was 84% (84 out of 100) for baby soap (6-sided box), 72% (72 out of 100) for gummy candies (bag, variable shape), 98% (98 out of 100) for aojiru green juice (4-sided plastic bottle), and 95% (95 out of 100) for a canned alcoholic beverage (cylindrical aluminum can). The reading success rate varied by up to 26% depending on the shape of the product (3D object).

In the above Test 1, it was found that it is sufficiently feasible for visually impaired people to read 2D codes with their smartphones, regardless of the degree of their visual impairment. However, it was discovered that increasing the success rate depends on whether or not the presence of a 2D code and its location could be determined tactilely (via touch). It was also found that the reading success seems to be greatly affected by the size of the 2D code and the shape of the printed material. (Since we did not pay attention to the size of the 2D code in Test 1, we decided to make it clear in Test 2.) On the other hand, we learned that if the 2D codes are the same size using the same paper, the position (top or bottom, left or right) of the 2D code on the printed material is insignificant, and success depends more on the degree of proficiency of the actual act of scanning the 2D code. Additionally, through questionnaires and observation of the tests, it was found that although visually impaired people feel very stressed if they cannot scan the 2D code within one minute, even if it takes a long time, they will still try to scan the code if there is information they want to receive. It was also found that information pertaining to groceries and beverages (i.e., 3D objects) was the most wanted day-to-day information for more than half of the total number of participants. Furthermore, it was observed that visually impaired people experienced difficulty in keeping the camera level, and they failed to scan the 2D code because the camera was held too close to the code.

Therefore, in Test 2, we varied both the size of the 2D code and the tactile marker for indicating the code's location, and we made note of both the differences produced by each variation and what setup was suitable for each.

Proof of Concept Test 2 (Conducted From Oct. 1, 2018, to Nov. 2, 2018)

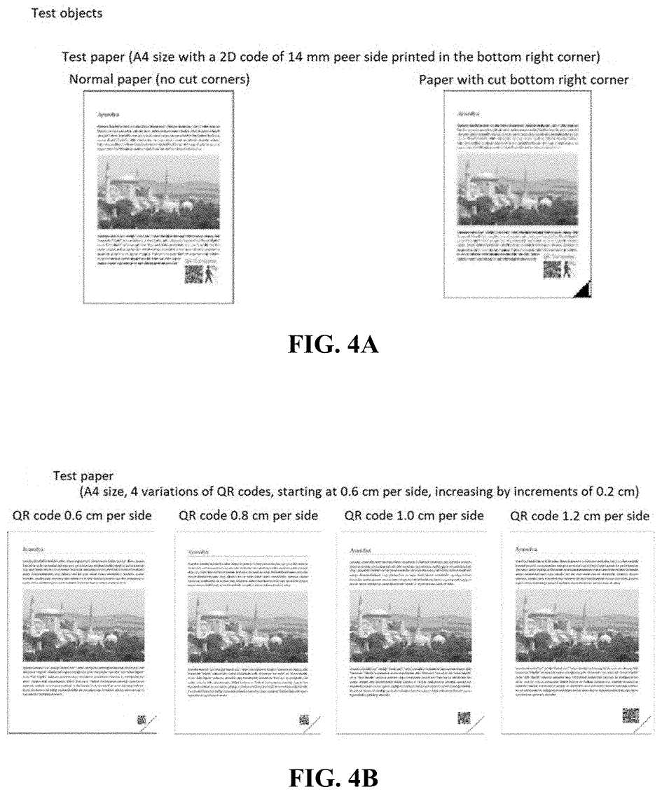

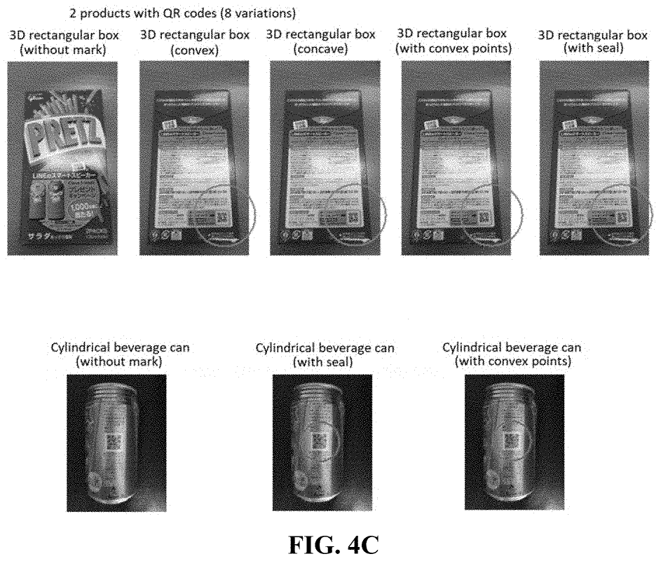

In Test 2, the participants were seated in a well-lit room, as in Test 1, and the same smartphone (2D code reading application) was used to read 2D codes of different sizes with varying tactile markers on the test objects placed on the specified table. The objects used for Test 2 are as follows: a test paper as shown in FIG. 4A (A4 size with a 2D code of 1.4 cm per side printed in the bottom-right corner) without a cutout and a paper (same specifications) with a cutout on the lower right edge; test papers as shown in FIG. 4B (A4 size) with cutouts on the lower right edge and 2D codes of 0.6 cm, 0.8 cm, 1.0 cm, and 1.2 cm printed in the bottom right; and two products (printed product packaging, one rectangular and one cylindrical) as shown in FIG. 4C with 2D codes. The objects used for Test 2 are as follows: a test paper as shown in FIG. 4A (A4 size with a 2D code of 1.4 cm per side printed in the bottom-right corner) without a cutout and a paper (same specifications) with a cutout on the lower right edge; test papers as shown in FIG. 4B (A4 size) with cutouts on the lower right edge and 2D codes of 0.6 cm, 0.8 cm, 1.0 cm, and 1.2 cm printed in the bottom right; and two products (product packaging, one rectangular and one cylindrical) as shown in FIG. 4C with 2D codes. In total, eight types of items were prepared according to the way the 2D codes were attached. They are, respectively, rectangular (without mark), rectangular (convex), rectangular (concave), rectangular (with convex points), rectangular (with seal), cylindrical (without mark), cylindrical (with seal), and cylindrical (with convex points).

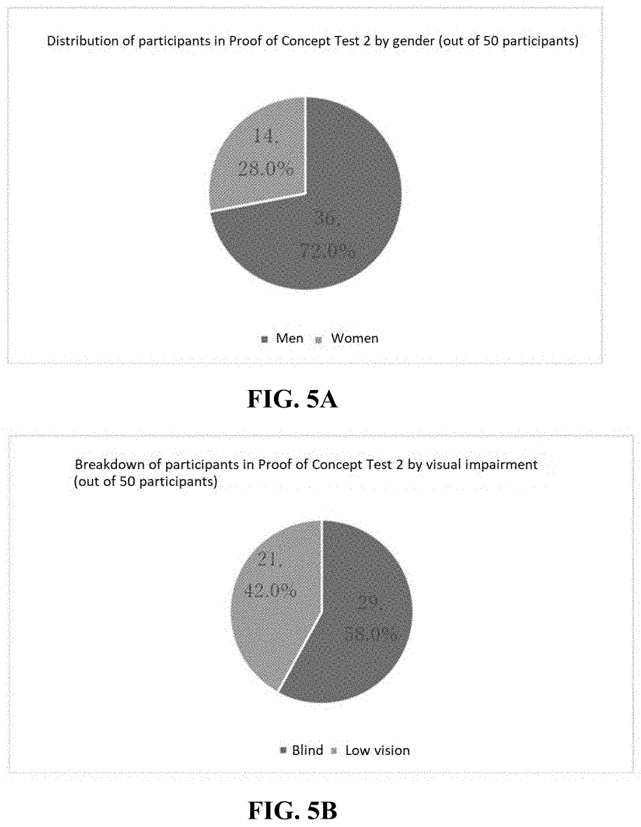

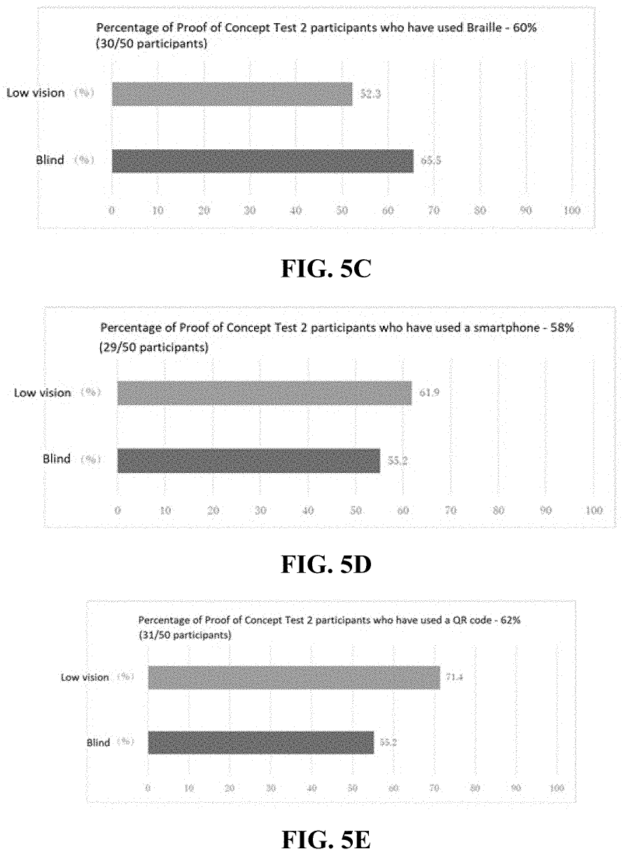

As shown in FIGS. 5A-5B, there were 50 visually impaired participants, with 36 males and 14 females, and their average age was 52.9 years. 29 participants were blind and 21 had low vision, and the Braille usage rate was 60.0% (30 people). FIG. 5C shows the percentage of Braille users, and, as in Test 1, the percentage of Braille users was low among low-vision participants. As shown in FIG. 5D, 58% (29) of the participants had experience using smartphones, 50% (25) had experience using voice reading functions (VoiceOver and TalkBack), and 62% (31) had experience using 2D codes (QR codes), as shown in FIG. 5E.

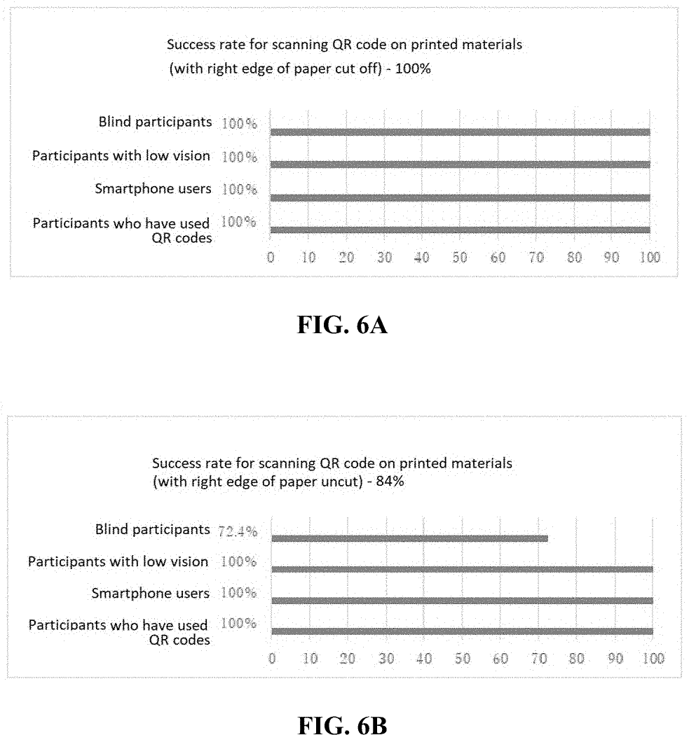

The results of Test 2 showed that the likelihood of participants succeeding in scanning a 14×14 mm 2D code located on the bottom-right side of printed material (paper) within one minute, as shown in FIG. 4A, with the lower right corner of the paper diagonally cut, was 100% (50/50 participants). A detailed breakdown is shown in FIG. 6A. The success rate was 100% for totally blind people (29), people with low vision (21), smartphone users (29), and people who had experience using 2D codes (31). The probability that participants successfully scanned the 14×14 mm 2D code printed in the bottom-right corner of the printed material (paper) with no diagonal cut within one minute, shown on the left side of FIG. 4A above, was 84% (42/50 participants). The detailed breakdown, as shown in FIG. 6B, was 72. 4% (21/29) for the totally blind, 100% (21/21) for those with low vision, 100% (29/29) for smartphone users, and 100% (31/31) for those with experience using 2D codes.

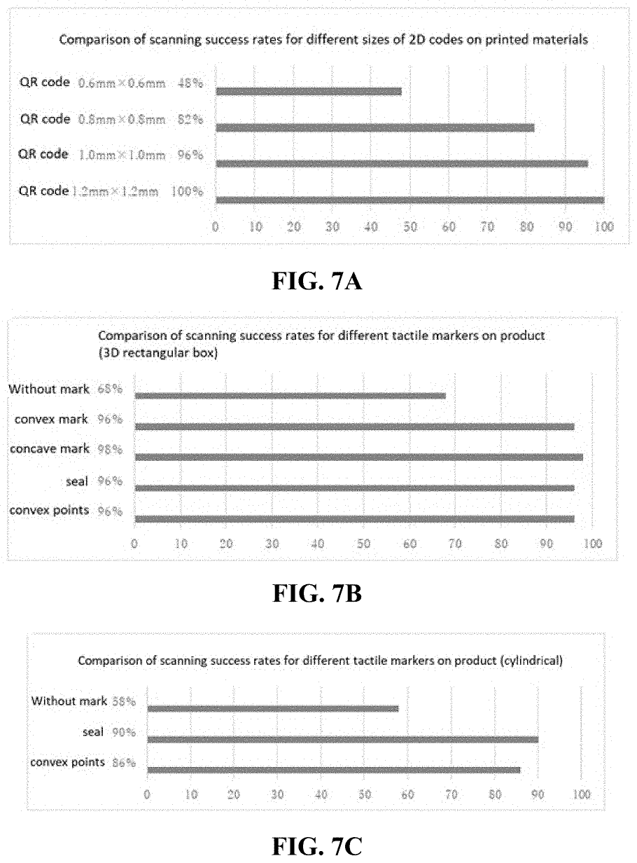

The success rate of participants scanning a 2D code within one minute when randomly presented with 2D codes of 0.6 cm, 0.8 cm, 1.0 cm, and 1.2 cm per side printed on the bottom-right side on the test paper (A4 size) shown in FIG. 4B above with the bottom-right corner cut diagonally is shown in FIG. 7A. The success rates were 48% (24/50) for the 0.6 cm×0.6 cm 2D code, 82% (41/50) for the 0.8 cm×0.8 cm 2D code, 96% (48/50) for the 1.0 cm×1.0 cm 2D code, and 100% (50/50) for the 1.2 cm×1.2 cm 2D code. Therefore, it can be said that statistically favorable results are obtained when a 1.0 cm×1.0 cm or larger 2D code is printed on the lower right side of the paper, and the lower right edge is diagonally cut.

Furthermore, when participants were randomly presented with different tactile markers attached to the 2D code on the same product (product packaging in a rectangular shape) as shown in FIG. 4C above, the success rate of reading the 2D code within one minute was, as shown in FIG. 7B, 68% (34/50) for the long rectangular product packaging with no marker on the 2D code, 96% (48/50) for the long rectangular product packaging with a convex tactile marker on the 2D code, 98% (49/50) for the long rectangular product packaging with a concave tactile marker on the 2D code, 96% (48/50) for the long rectangular product packaging with a seal on the 2D code. (48/50), and 96% (48/50) for a long rectangular product packaging with convex points around the 2D code for tactile recognition.

Furthermore, the success rate of reading the 2D code within one minute when the subjects were randomly presented with different tactile markers around the 2D code on the same product (cylindrical product packaging) in FIG. 4C above was, as shown in FIG. 7C, 58% (29/50) for the cylindrical beverage can without any markings around the 2D code, 90% (45/50) for the cylindrical beverage can with a seal attached to the 2D code, and 86% (43/50) for the cylindrical beverage can with convex points around the 2D code.

From the examples in FIGS. 7B-7C, we determined that the presence or absence of a tactile marker are important for the reading success rate for visually impaired people, that differences in the tactile marker do not significantly affect the code reading success rate, and that the type of tactile marker should be determined by factors such as ease of manufacture and prevention of confusion with other tactile features.

The results of Test 2 stated above are one step ahead of the results of Test 1, and it was found that in order for a visually impaired person to successfully read the 2D code with their smartphone, ideally the 2D code should be a certain size or larger. Specifically, the 2D code should be 10 mm×10 mm or larger. Additionally, it was found that it was most important to attach a marker to the 2D code for tactile recognition.

An example of an ideal 2D code for visually impaired people which takes into account the results of the two tests is described below.

Example of the Present Invention: a 2D Code for Visually Impaired People

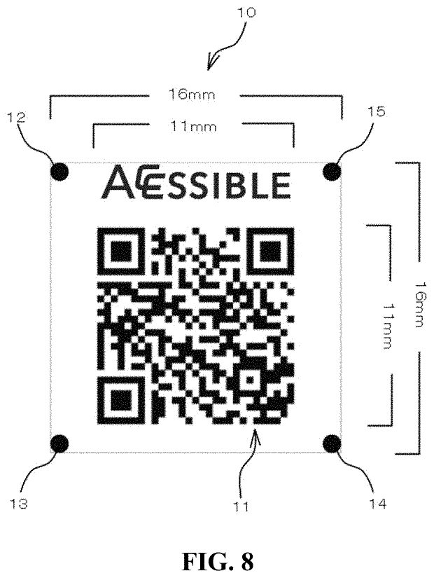

FIG. 8 illustrates the present invention's 2D code (10) for visually impaired people. This 2D code (10) for visually impaired people has a data matrix 2D code (11) and Braille-like convex points (12-15) at the four corners around the code. From the above-mentioned tests, a tactile marker for the 2D code (11) is necessary, and, even in the case of product packaging, it is easy to form convex points by using a press, etc., at the same time as the printing of the product's usual explanations, its design, and the 2D code (11).

In the example of FIG. 8, the 2D code (11) is 11 mm×11 mm, and the distance between each of the convex points 12 to 15 around the code (distance between convex points 12 and 13; distance between convex points 13 and 14; distance between convex points 14 and 15; and distance between convex points 12 and 15) is 16 mm. The reason for this is that, first of all, the success rate of reading a 2D code within one minute is high within the range of 10×10 mm to 14×14 mm as demonstrated in the tests, hence it is ideal to print 2D codes within that range. Since there have been no empirical tests on 2D codes larger than 14×14 mm, code size can at least be stated as effective up to a size of 14×14 mm, but the degree of reading success is usually considered to be higher for larger codes. Therefore, the success rate should be thought of as something that changes relative to available excess printing space.

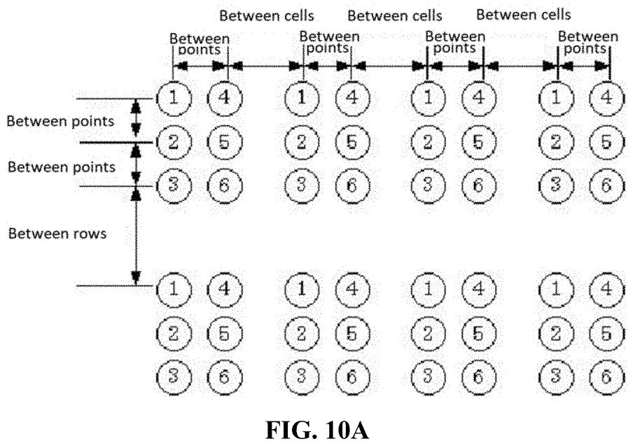

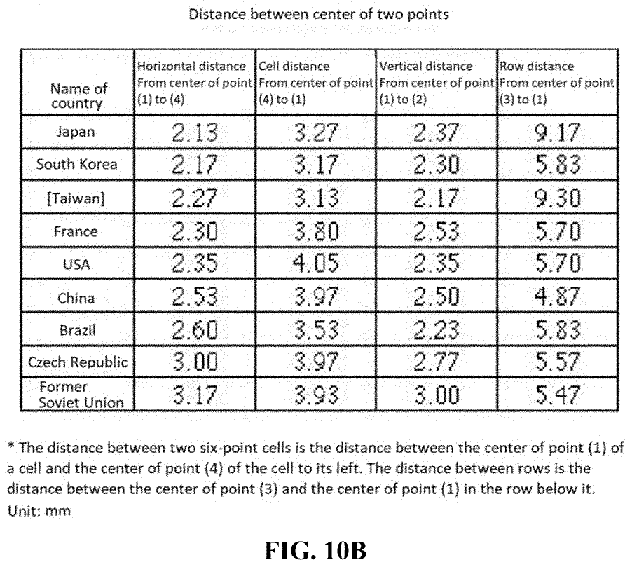

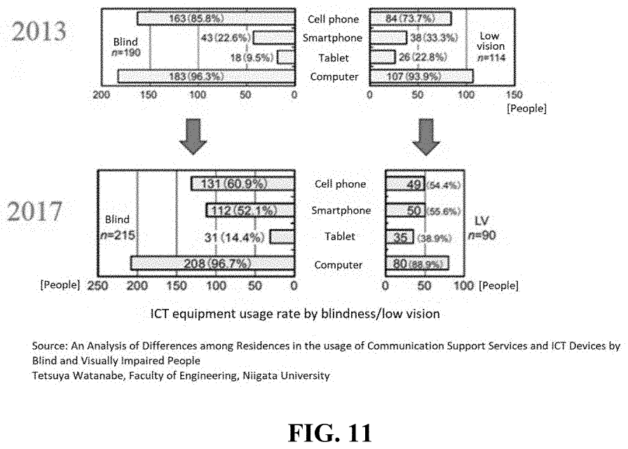

The distance from center to center of Braille raised dots is explained here, with reference to FIGS. 10A-10B. As shown in FIG. 10A, a Braille cell is essentially composed of six raised dots (two parallel columns of three raised dots per column). These cells are lined up from left to right in rows, and the spaces between rows are called line spacing. The side with the raised dot is called the “front” of Braille, and it is read tactilely with the fingertips from left to right. The center-to-center distances between dots in each country's Braille system are shown in FIG. 10B. From these results, it can be seen that if the line spacing is about 12 mm, which is much larger than the Taiwanese line spacing of 9.30 mm, visually impaired people will recognize that the raised dots are not Braille but something different. Therefore, the distance from center to center of the convex points 12-15 should be 12 mm or greater. In the example given in FIG. 8, the distance is 16 mm.

In addition, the 2D code reading success rate decreases if the surface is uneven. On the other hand, the base diameter size of a typical Braille raised dot is Φ=1.4 to 1.5 mm (height h=0.3 to 0.5 mm). Therefore, in consideration of misalignment or shadows of the convex points (12-15), the result of when a special printing machine is not used, it is preferable to separate the convex points (12-15) from the 2D code by about 2 mm and make the distance from center to center of the convex points (12-15) at least 14.0 mm. In the example shown in FIG. 8, the distance is 16 mm for the sake of certainty. (However, this is the distance between the outer edges of the convex points (12-15); the distance from center to center is less than 16 mm).

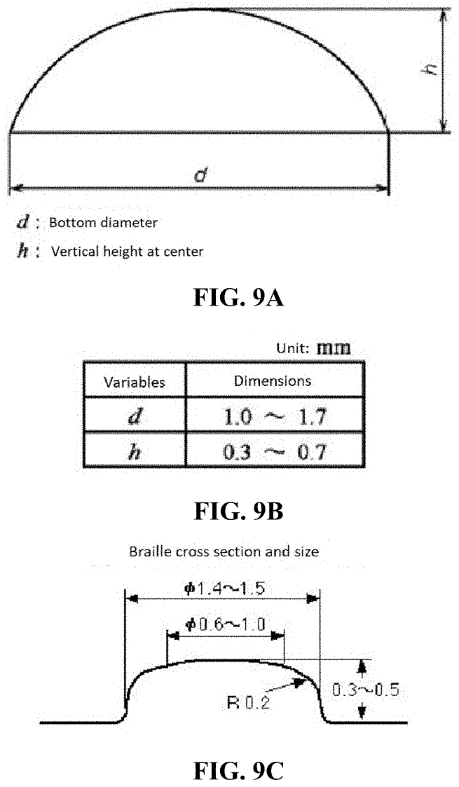

Next, FIG. 9A shows a schematic illustration of the cross-section of each of the convex points 12-15, and FIG. 9B shows their dimensions. The cross-sectional of a convex point 12-15 is half-dome shaped, with the diameter of the bottom surface d (Φ) equal to 1.0-1.7 mm, and the vertical height of the center of the point h equal to 0.3-0.7 mm. From above, if there is no issue with precision, misalignment or damage, it is a regular circle. The cross-section of a generic Braille raised dot is shown in FIG. 9C. The convex points 12-15 are roughly the same size as those of normal Braille. However, as shown in FIG. 9C, the general shape of Braille is more like the bottom of an upside-down pan, as shown in FIG. 9C, than a half-dome shape, and there are many examples of where the base (hereinafter also referred to as the “foothills”) rises up to form a gentle half-dome shape at the top. Braille must not damage the fingertips of visually impaired people. Convex points (12-15), while needing to satisfy this requirement, must also be easy to produce on a generic product packaging production line (via pressing, etc.) rather than with a specialized Braille production machine. In addition to this, it is necessary to prevent the shadows of the convex points (12-15) from overlapping with the 2D code (11). Combining these considerations leads to a half-dome shape as shown in the examples in FIGS. 9A-9B.

It should be noted as a result of Test 2 that a concave area can also work well as a tactile marker on product packaging (3D objects) for visually impaired people as an alternative to convex points (12-15). In the case that a concave area is used, the 2D code (11) is contained within the bottom of a concave area on the product packaging, as shown in FIG. 4C (with concave area).

### EXPLANATION OF THE SIGNS

10 . . . 2D code for visually impaired people

11 . . . 2D code

12 to 15 . . . Convex points

1. A printed matter with an identification code for visually impaired people to help visually impaired people understand the printed content or the contents of the item packaged by the printed material, wherein the identification code for visually impaired people is displayed on the surface of the printed matter and is readable by a mobile device that has a camera and a specified identification code reading function,
the identification code for visually impaired people is formed with Braille-like convex points protruding outward at multiple points around the identification code for visually impaired people, and the distance between each convex point has a predetermined distance larger than the distances used between raised dots in adjacent Braille cells.

2. The printed matter, according to claim 1, wherein the identification code for visually impaired people is a data matrix 2D code and the convex points are positioned at the four corners around the identification code for visually impaired people.

3. The printed matter according to claim 2, wherein the 2D code for visually impaired people is characterized as a square measuring at least 10 mm, and the distance from center to center of each convex point is 14 mm or greater.

4. The printed matter according to claim 1, wherein each convex point is half-dome shaped, with a base diameter of 1.0 mm to 1.7 mm, and a height at the center of 0.3 mm to 0.7 mm.

5. A printed matter with an identification code for the visually impaired to enable a visually impaired people to understand the content information of a three-dimensional object packaged with the printed matter, wherein the identification code for the visually impaired is readable by a mobile device that has a camera and a specified identification code reading function, and is displayed on the surface of the printed matter,
the identification code for the visually impaired is a 2D code printed on the surface of the printed matter in the bottom of a recess having a square-shaped bottom surface, and the identification code for the visually impaired is square-shaped of 10 mm or more and the distance of one side of the bottom surface is 14 mm or more.

6. The printed matter according to claim 1, characterized by an identification code for visually impaired people to enable a visually impaired people person to understand the content information of a three-dimensional packed with the printed matter,
wherein when a visually impaired people reads the identification code for visually impaired people with the mobile device, a web page containing detailed information on the three dimensional object object is displayed and the visually impaired people thereby receives spoken detailed information on the product through the voice reading function of their mobile device.
